(19) United States
(12) Patent Application Publication
(10) Pub. No.: US 2006/0209071 A1
(43) Pub. Date: Sep. 21, 2006

(54) Expanded graphical interface for information cognition

(76) Inventors: Mike Gilger, Satellite Beach, FL (US); Kerry Gilger, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/367,789

(22) Filed: Mar. 3, 2006

Related U.S. Application Data
(60) Provisional application No. 60/658,920, filed on Mar. 4, 2005.

(51) Int. Cl. G06T 11/20; G06F 3/00; G06F 17/00

(52) U.S. Cl. 345/440; 715/764

(57) ABSTRACT

A graphical interface for information cognition uses knowledge enhanced graphical symbols. The interface is implemented using a visual language and visual metaphors which enable quick and ready understanding of the states of complex systems represented using the language. Individual knowledge enhanced graphical symbols may have the capability of representing or summarizing a plurality of other knowledge enhanced graphical symbols and may be selectively activated to display the underlying knowledge enhanced graphical symbols and to receive user input of state information.

### CROSS REFERENCE TO RELATED APPLICATIONS

This application claims priority to and incorporates by reference in its entirety U.S. Provisional Application 60/658,920, filed Mar. 4, 2005, by inventors Mike Gilger and Kerry Gilger entitled Expanded Graphical Interface For Information Cognition.

### BACKGROUND OF THE INVENTION

1. Field of the Invention

This application relates to the field of information processing and display and more particularly to techniques for improved data visualization.

2. Description of the Prior Art

The advent of computer systems for information acquisition, as well as the increasingly information intensive society in which we live, result in decision makers routinely being required to assimilate larger and larger amounts of information, much of which, in fact, is produced by automated information gathering systems. Unfortunately, this information load continues for the most part to be reported as alphanumeric information, either in printed reports or via other display systems such as computer terminals. The human brain, however, is a better image processor than it is a calculator or character processor. Thus, while the brain is capable of assimilating and using alphanumeric information, it more rapidly assimilates images. It is, therefore, desirable that new methodologies of data display be developed which take advantage of these processing characteristics of the human brain.

Barriers to rapid understanding also result from language differences. For example, although people worldwide recognize the image of a chair, its description in textual form appears different in different languages. Similarly, descriptions of more complex datasets also appear different because of the different characters sets used around the world to describe them.

U.S. Pat. No. 5,321,800 to inventor Michael F. Lesser, describes knowledge enhanced graphical symbols (KEGS®) utilized as a graphical interface for information cognition. The graphical interface for information cognition description has provided a basis for a language (the GIFIC® language). There are high order benefits that come from a grouping of KEGS® into a set of KEGS® (KEGSET®) and from keeping the shape of the KEGSET® consistent so that the mind may perform pattern matches on those shapes.

### Problems of the Prior Art

If a set of data is presented where there may not be a consistent number of data or where additional metrics are desired, the potential solution would be to add and remove knowledge enhanced graphical symbols as necessary to accommodate the different additional types of data. However, mechanisms such as this to manage a dynamically changing number of KEGS® would cause cognitive degradation of the language. Since a higher level function of the language allows the mind to “pattern” map the overall shape of a KEGSET®, changing the shape would then negate the powerful pattern matching augmentation that the KEGSET®s provide, which is not acceptable.

### BRIEF SUMMARY OF THE INVENTION

The invention of this application is directed to enhancements over the prior art data visualization techniques which solve the problems of the prior art.

This is accomplished, in accordance with one aspect of the invention, by providing a selective expansion or “Flyout” display of a KEGS®, whereby additional KEGS®, representing the underlying data elements which are utilized to construct a higher level KEGS® can be displayed.

In another aspect of the invention, knowledge enhanced graphical symbols of the prior art are expanded to include the capability to provide direct user input effecting the state of the display of the KEGS® and the underlying data.

These and other aspects of the invention are described in more detail with reference to the following drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a symbolic representation of a knowledge enhanced graphical symbol (or KEGS®) in accordance with one aspect of the invention.

FIG. 2 illustrates the use of color applied to the display of a KEGS® to depict variations above and below expectations in accordance with one aspect of the invention.

FIG. 3 illustrates exemplary mapping of bounded numeric data to the color states of a KEGS®.

FIG. 4 depicts a number of KEGS® grouped as a set (KEGSET®) for display and manipulation as a unit.

FIG. 5 depicts a KEGS® with enhanced (Flyout) properties as part of a KEGSET®, in accordance with one aspect of the invention.

FIG. 6 depicts expanded KEGS® of a Flyout group with a drop down menu from a KEGS® selected for user direct adjustment of the state of the selected KEGS® and/or its underlying data in accordance with one aspect of the invention.

FIG. 7 shows an example of edits that can be applied to the states of a selected KEGS® of the Flyout group of FIG. 6.

FIG. 8 is a group of KEGSET®s arranged in a metaphorical pattern corresponding to a position on a map of the United States with a Flyout expansion of a Jacksonville KEGS®.

FIG. 9 shows the Jacksonville KEGSET® in more detail with a Flyout of the expenses KEGS® of that KEGSET® shown.

FIG. 10 shows an alternative Flyout arrangement of the CIT KEGS® of KEGSET® 4372.

FIG. 11 shows an alternative Flyout arrangement activated on a click of a KEGS®.

FIG. 12 shows an alternative Flyout arrangement that can be activated by a click or a hover over a KEGS®.

FIGS. 13A and 13B illustrate how a quick visual inspection of a display can immediately identify KEGSET®s that deviate from expectations.

FIG. 14 is a block diagram of a computer interconnected over a network with a server providing a source of data, such as a database.

### DETAILED DESCRIPTION OF THE INVENTION

In using the graphical interface for information cognition techniques in the corresponding language supporting that, a high order benefit comes from the grouping of KEGS® into a KEGSET® and keeping the shape of the KEGSET® consistent so that the mind may perform pattern matches on those shapes. To further explain this, understand that GIFIC® is designed to take advantage of the brain's ability to differentiate colors very quickly, allowing us to remove cognitive steps to process data without too many colors to overload the quick processing of the information behind those colors. For example, when we look at numbers on a screen, we typically go through many processing steps to determine what that number “means” to us. Roughly, those steps are as follows:
1. Look at the number
2. Determine what the number is (i.e. the label such as cost of sales)
3. “Read” the number—the mind uses pattern matching to get a value out of the numbers
4. Remember the “baseline”, “desired”, or “expected” value
5. Compare the “read” number with the baseline to perform the comparison (above or below what we desire)
6. Start processing results

As can be seen, there are a lot of steps one goes through to get meaning out of data in the typical way it is displayed today.

With the GIFIC® language, the colors and location allow the mind to perform several of these steps together without the need of the extra processing. Since GIFIC® actually incorporates the label and the baseline plus difference from baseline (knowledge) into the language, these steps are “combined” so that the brain doesn't have to do these steps. Here are the necessary steps using the GIFIC® language:
1. Look at the KEGS®
2. “Read” the KEGS® (position is label, color is expectation to baseline comparison rolled up into one—no need to remember baselines or do comparisons)
3. Start processing results

However, this isn't where the power of the GIFIC® language leaves off. By grouping the KEGS® into KEGSET®s, one can get a whole story from the pattern that forms (a bigger picture, so-to-speak). This is much like when a child first learns to read. They sound out each letter, do the consonant blends, vowel sounds, run them all together, and then say the word. As they continue to do this, the brain (being either lazy or just efficient) will recognize the pattern of letters that form that word, and soon the child “sight” reads the words. The brain looks at the pattern of the letters, finds a good match in memory, and produces the match and associated meaning for the match.

Reports and numbers do not have a standard pattern, and the brain (while immediately recognizing numbers) has to process the “meaning” each time. GIFIC®, however, creates an actual language for the information, and indeed creates patterns for the mind to remember. And after a small amount of time using the GIFIC® language, instead of processing each KEGS® (or letter), the brain will recognize the complete pattern of the KEGSET®, and just from the glance, one would know that they have an inventory/supply problem because the associated KEGS® that show that revenue is down, processing time is up, and order errors are high will have been implanted as a pattern in the brain for instant recognition. The pattern for inventory/supply problem will for the most part, always be the same.

Thus, if we arbitrarily change the shape of the KEGSET®, it would be the same as adding and removing characters to a word—which would prevent the mind from performing a pattern “save” on the word, which in turn would force the mind to have to re-process the information individual every single time it was presented with the information—a significant weakness in current visualization techniques.

Therefore, a way had to be found that would allow for the information to be displayed while preserving this higher-order benefit of the GIFIC® language (as well as prevent unnecessary clutter, or non-necessary data to be displayed when not needed). The solution: the “Flyout” KEGS®.

A KEGS® is an elemental display unit which is enhanced with knowledge. In the current implementation, when a display is designed, an expert defines the criteria for each KEGS® such as (1) the values for the range of expectations—from severely high to severely low; (2) if the data is pushed or polled from the data source, if polled how often the data source should be polled for changes in the data; (3) if historical data needs to be seen with this data; and (4) if a critical state should trigger an event, such as an email notification. Thus built in expertise takes the responsibility and the time for analysis of the presented data out of the hands of the viewer.

Several advantages result from building using experts. Once the experts'knowledge has been built in, many things become possible. The expert can do other things. Reviewing data on the part of the user takes a fraction of the time previously necessary. Data analysis can be current and readily apparent, by virtue of it being displayed in color code. Additionally, trends can be identified and a defined state can trigger an email notice or action service.

KEGSET® is an arrangement of a plurality KEGS® which can be mapped to a particular metaphor, such as a physical system. For example, the KEGS® in U.S. Pat. No. 5,321,800 map to various medical systems and subdivisions of the human body. The metaphorical mapping of the KEGS® to the physical system, allows a user to identify immediately, upon visual inspection, the portion of the system that deviates from expectations.

A graphical interface for information cognition, uses KEGS® and KEGSET® in a visual display language to permit rapid display and understanding of the condition of the systems which the KEGS® and KEGSET®s represent.

FIG. 1 is a symbolic representation of a knowledge graphical symbol (or KEG®) in accordance with one aspect of the invention. KEGS® 100 is a rectangular display element which constitutes an elemental display unit from which KEGSET®s and more highly complex organizations of KEGS® can be formed.

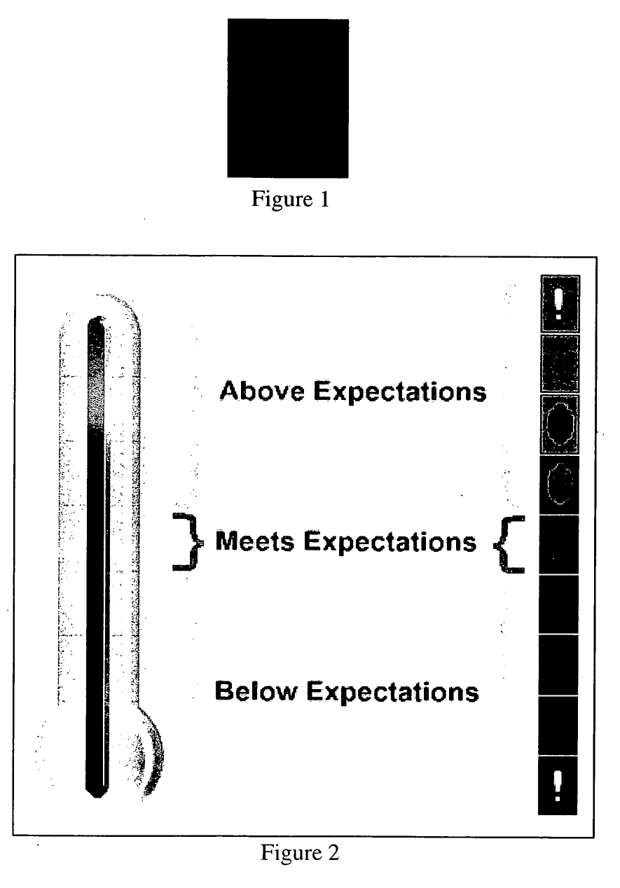

FIG. 2 illustrates the use of color applied to the display of a KEGS® to depict variations above and below expectations in accordance with one aspect of the invention.

FIG. 2 describes a color analogy utilized for the assignment of values which are very useful in many applications. The color arrangement shown is exemplary. Other color arrangements or dialects can be utilized as desired or convenient for particular applications. In FIG. 2, on the left is a thermometer reminding one of the color associations we have with temperature, namely higher temperatures are associated with warm colors and lower temperatures are associated with cool colors. These associations are a good way to remember the standard symbols for KEGS®. Above expectations, the colors would generate a symbol using a warm color, such as the orange shown at the high end of FIG. 2. Below expectations, the symbols would use a cool color, such as blue, the green in the middle is associated with the green of a traffic light which implies that it is ok or that one can go.

There are four generally utilized types of KEGS®, depending on the data that they represent, they are: (1) bounded numeric KEGS®, (2) quantifiable KEGS®, (3) multi-state KEGS® and (4) binary KEGS®.

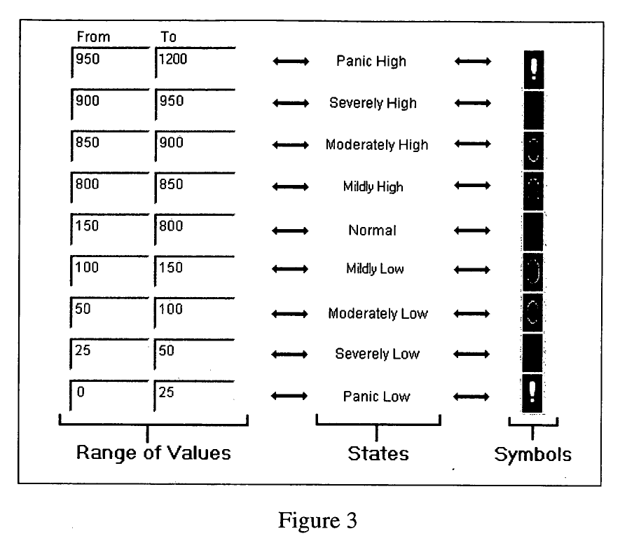

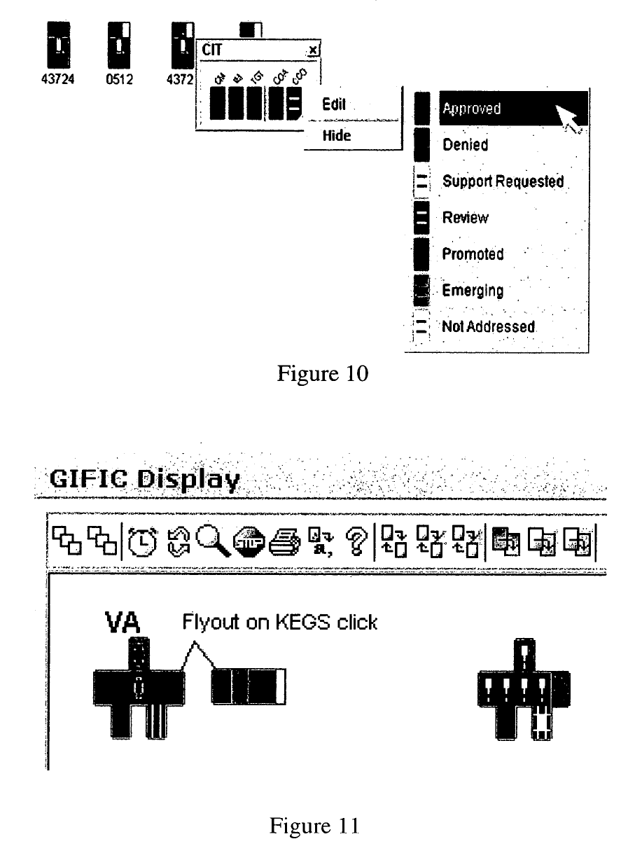

FIG. 3 illustrates an exemplary mapping of bounded numeric data to the color states of a KEGS®. If the variable of interest is bounded within the range between 0 and 1,200, an expert would understand that a certain portion of the range, in the example shown the portion from 150 to 800, constitutes a normal condition. Gradations above and below the normal range then are accounted for with the appropriate range definitions shown in FIG. 3. The color states may also represent specific states of data such as multistate which is shown in FIG. 10 (e.g. “approved, reviewed, etc.). Obviously any type of state could be patterned like this.

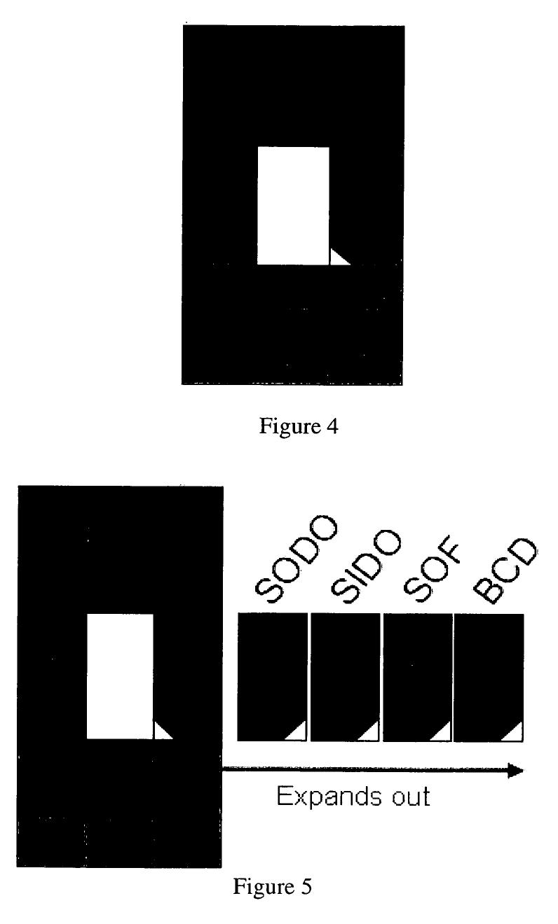

FIG. 4 depicts a number of KEGS® grouped as a set (KEGSET®) for display as a unit. For this example, the set of data represents a target being tracked for potential elimination. The illustrated KEGS® within the KEGSET® apply to all types of targets, and are consistent. The problem is that for each type of target, various different organizations may be responsible for gathering and confirming data associated with the target, and this could involve, for example, 4 pieces of information for one target, and 14 for another (the specific number is arbitrary). As presented above, the current level of the GIFIC® language could support this by adding and removing KEGS® on-the-fly, but this would be at the cost of the higher-level pattern matching that the KEGSETS® provide. Therefore, an enhancement to the language to accommodate this is necessary, and will be explained below.

The specific meanings of each of the KEGS®s in not necessary for this example. Understand that the right middle KEGS® represents the “summary” value that could be made up of 1 or more arbitrary values (it has the small triangle in the lower left corner of the KEGS®). The white triangle simply provides a usability hint to the viewer that this KEGS® represents a value based on one or more aggregated KEGS® (referred to as a “Flyout KEGS®”. The aggregation could be anything from a simple score, to an extreme, to a complex formula that could contain weights and external calculi to determine what the “rolled-up” score should be.

FIG. 5 depicts a KEGS® with enhanced (Flyout) properties as part of a KEGSET® in accordance with one aspect of the invention. If the Flyout KEGS® shows a state that is not as expected, the viewer simply activates the “Flyout” function, which will immediately show all of the KEGS® that were aggregated into the top-level Flyout KEGS®. As can be seen, for this example, there were 4 KEGS® that make up the aggregated Flyout KEGS®. Above each KEGS® is the KEGS® title which represents the specific piece of data that the KEGS® is showing. In this case, the title is required, as the number of these KEGS® is arbitrary as already noted above. Therefore, the position does not dictate the title of the KEGS® like the fixed position of a KEGSET®, though as will be shown below, there are examples where the Flyouts are fixed, and thus the positional benefit of the KEGS® will allow that the title not be displayed.

Notice that in the Flyout KEGS®, there is a triangle in the lower right corner of each of the KEGS®. This again provides a hint that this KEGS® is an “Input KEGS®”, meaning that this KEGS® can be modified directly through user input on the KEGS®. This may not always be the case (some KEGS® will only be modifiable from external systems, and only when they update the database will they be reflected in the currently displayed KEGS®), and in cases where the KEGS® is not an Input type KEGS®, the triangle would not be present.

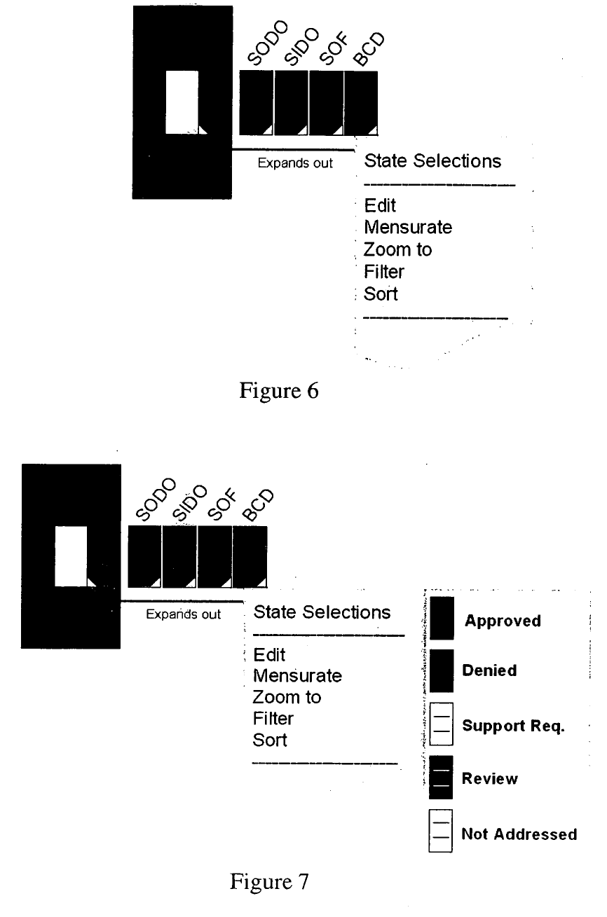

FIG. 6 depicts expanded KEGS® of a Flyout group with a drop down menu from a KEGS® selected for user direct input in accordance with one aspect of the invention. When a KEGS® has the capability for receiving direct input, the user will have the ability to activate a change list from the KEGS®, and be able to select a new state or value for the KEGS® from this drop-down list. In this example, it is a drop-down menu—the actual visualization of this is not important, only that the view presented has the ability for the user to change these values directly. The particulars of the drop down menu displayed is dynamic, that is, it changes depending on the properties of the KEGS® which is used for its activation.

FIG. 7 shows an example of edits that can be applied to the state of a selected KEGS® of the Flyout group of FIG. 6. In FIG. 7, an interface much like the menu will present the capability to change the state as can be seen from the figure. Note that any type of KEGS® can be displayed in the Flyout, and the potential states and values will be based on the specific implementation—this example is only one of many potential examples of possible states that are available. For instance, it could display a dialog of potential choices, or even allow a rocker switch directly on the KEGS® to change the value through a process of selecting the upper or lower half of the KEGS®. In the case of Bounded Numeric (value driven for a state), a dialog box could be displayed that allows for alpha/numeric entry, or a state shown for each value range that can simple be selected.

There appears to be a general Principle of Selective Omission of Information at work in all biological information processing systems. The sensory organs simplify and organize their inputs, supplying the higher processing centers with aggregated forms of information which, to a considerable extent, predetermine the patterned structures that the higher centers can detect. The higher centers in their turn reduce the quantity of information which will be processed at later stages by further organization of the partly processed information into more abstract and universal forms. (Resnikoff, H. L. (1987). The Illusion of Reality. New York: Springer-Verlag, p. 19)

As described above, GIFIC® already reduces the cognitive steps required to produce patterns that can be detected and processed quickly by the human brain. The Flyout also provides a way of mimicking this “Principle of Selective Omission” by organizing and aggregating lower levels of information into the Flyout KEGS®. Typically, this is only performed on data that is not necessarily important to the top level decisions and pattern matching that the KEGSET® was designed to provide. It is supporting information that should typically be shown when something at the higher level requires it.

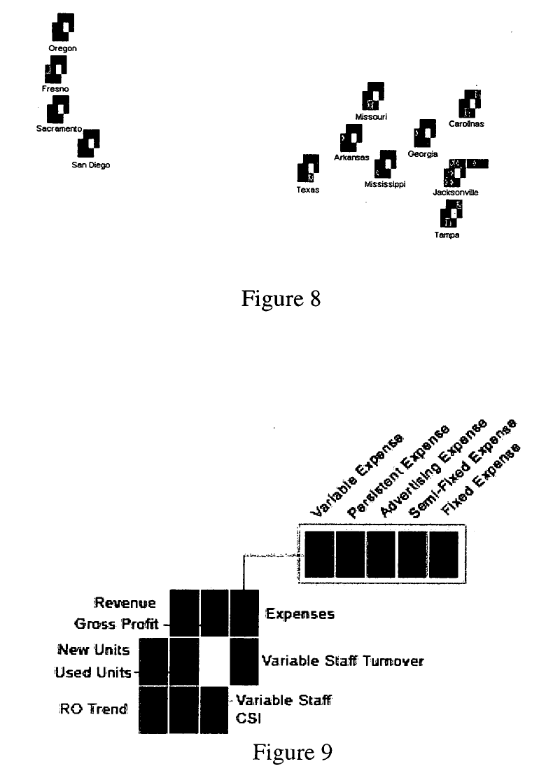

FIG. 8 is a group of KEGSET®s arranged in a metaphorical pattern corresponding to a position on a map of the United States with a Flyout expansion of the Jacksonville KEGSET®.

FIG. 9 shows the Jacksonville KEGSET® and a Flyout of the expenses KEGS®. In this case, the Flyout is used to aggregate several aspects of expenses. Obviously many forms of information can be aggregated as required, this is simply one of many potential aggregations used to help describe the function of the invention.

This example shows at the aggregation use for the Flyout providing for visual simplification. Using the Flyout to roll up the various sub-components of Expenses keeps the display from being too cluttered, and these sub components are not important unless there is an actual issue with expenses. Thus, the Flyout is being used to hide information that only becomes important when there is an actual issue with the subcomponents that it describes. If we overload the individual KEGSET® with too many KEGS®, then the pattern recognition that the mind applies becomes limited (too many potential patterns to process). Using the Flyout in this mode allows the actual presentation of the data to be optimized as an overall business health indicator, and only if there are issues does the viewer activate the Flyout to gain a better understanding of why there may be a health issue. The flyout can be activated either by a user clicking on a KEGS® with flyout capability, by hovering over a KEGS® with flyout capability or by a software program upon detecting a state which should be brought to the attention of the user. The location at which the flyout is displayed is a matter of design choice, but it may often be located in close proximity to the KEGS® which triggers the flyout.

FIG. 10 shows an alternate Flyout arrangement of the CIT KEGS® of KEGSET® 4372.

FIG. 11 shows an alternative Flyout arrangement activate on a click of a KEGS®.

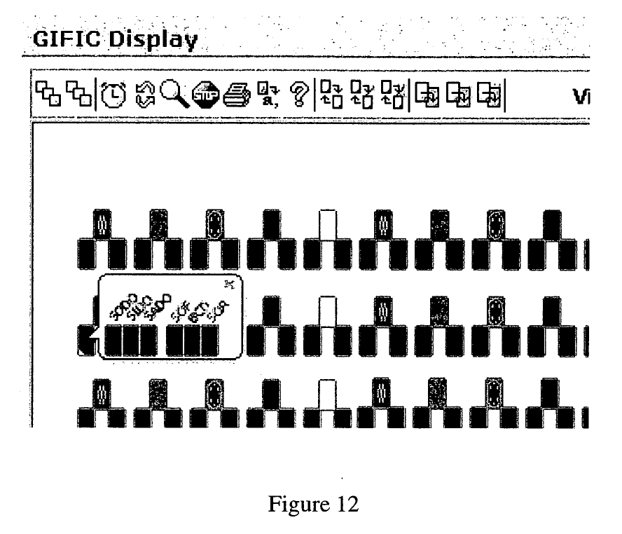

FIG. 12 shows an alternative Flyout arrangement that can be activated by a click or a hover over a KEGS®.

The preceding figures show different potential representations of the Flyout function as well as different representation for the input KEGS®. Notice that the Flyout KEGS® may be in groups to help better differentiate the various KEGS®. This does not necessarily signify that there is a logical grouping (although it can), it is an optional feature that can be used to quickly help interpret the display.

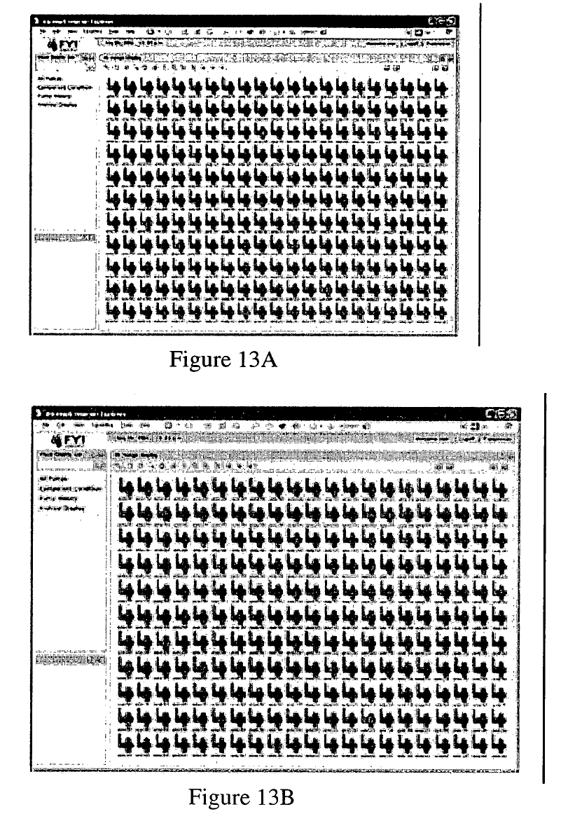

FIGS. 13A and 13B illustrate how a quick visual inspection of a display can immediately identify KEGSET® that deviate from expectations.

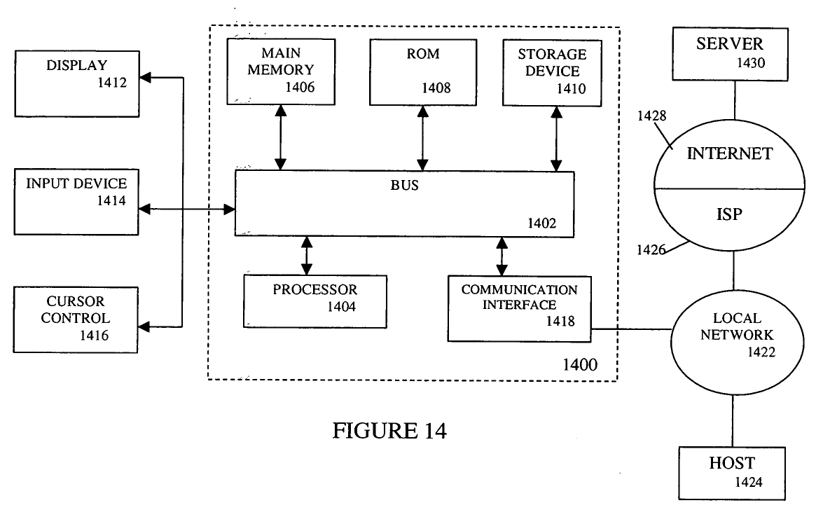

FIG. 14 is a block diagram of a computer interconnected over a network with a source of data, such as a database.

At least portions of the invention may be implemented on or over a network such as the Internet. An example of such a network is described in FIG. 14, attached.

FIG. 14 is a block diagram that illustrates a computer system 1400 upon which an embodiment of the invention may be implemented. Computer system 1400 includes a bus 1402 or other communication mechanism for communicating information, and a processor 1404 coupled with bus 1402 for processing information. Computer system. 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Computer system 1400 further includes a read only memory (ROM) 1408 or other static storage device coupled to bus 102 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT) or LCD display, for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 104 and for controlling cursor movement on display 1412. This input device typically has two degrees of freedom in two axes, a first axis (e.g., x) and a second axis (e.g., y), that allows the device to specify positions in a plane.

Computer system 1400 operates in response to processor 1404 executing one or more sequences of one or more instructions contained in main memory 1406. Such instructions may be read into main memory 1406 from another computer-readable medium, such as storage device 1410. Execution of the sequences of instructions contained in main memory 1406 causes processor 1404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1404 for execution. Such a medium may take many forms, including but not limited to, non-volatile media, volatile media, and transmission media. Non-volatile media includes, for example, optical or magnetic disks, such as storage device 1410. Volatile media includes dynamic memory, such as main memory 1406. Transmission media includes coaxial cables, copper wire and fiber optics, including the wires that comprise bus 1402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1404 for execution. For example, the instructions may initially be carried on a magnetic disk of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are exemplary forms of carrier waves transporting the information.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418. The received code may be executed by processor 1404 as it is received, and/or stored in storage device 1410, or other non-volatile storage for later execution. In this manner, computer system 1400 may obtain application code in the form of a carrier wave.

While various embodiments of the present invention have been illustrated herein in detail, it should be apparent that modifications and adaptations to those embodiments may occur to those skilled in the art without departing from the scope of the present invention as set forth in the following claims.

What is claimed is:

1. A method for displaying knowledge enhanced graphical symbols, comprising the steps of:
a. displaying one or more knowledge enhanced graphical symbols that contribute to the state of a first knowledge enhanced graphical symbol upon activation of the first knowledge enhanced graphical symbols.

2. The method of claim 1 in which the activation of the first knowledge enhanced graphical symbols comprises clicking on the first knowledge enhanced graphical symbol.

3. The method of claim 1 in which the activation of the first knowledge enhanced graphical symbols comprises hovering a cursor over the first knowledge enhanced graphical symbol.

4. The method of claim 1 in which the activation of the first knowledge enhanced graphical symbols comprises activation by at least one step of a computer program.

5. The method of claim 1 in which the first knowledge enhanced graphical symbol is visually different from other knowledge enhanced graphical symbols that do not summarize the states of said knowledge enhanced graphical symbols that contribute to the state of said first knowledge enhanced graphical symbol.

6. The method of claim 1 in which knowledge enhanced graphical symbols that may be activated to receive user input are visually different from other knowledge enhanced graphical symbols that lack that capability.

7. The method of claim 1 in which activation of a knowledge enhanced graphical symbol capable of receiving user input results in display of an input user interface.

8. The method of claim 1 in which display of knowledge enhanced graphical symbols occurs in the visual field of a user.

9. The method of claim 5 in which user input for a knowledge enhanced graphical symbol is received over the input/output capabilities of a computing device.

10. The method of claim 1 in which the states of knowledge enhanced graphical symbols are determined by information contained in a database.

11. A system for displaying knowledge enhanced graphical symbols, comprising:
a. a network;
b. at least one first computer, connected to the network, for displaying one or more knowledge enhanced graphical symbols, in which said displaying one or more knowledge enhanced graphical symbols comprises displaying one or more additional knowledge enhanced graphical symbols that contribute to the state of a first knowledge enhanced graphical symbol upon user selection of the first knowledge enhanced graphical symbols;
c. a server, connected to the network, for providing information from a database to said at least one first computer, for controlling the states of said knowledge enhanced graphical symbols.

12. The system of claim 11, in which one or more knowledge enhanced graphical symbols may be activated to receive user input.

13. The system of claim 12 in which said one or more knowledge enhanced graphical symbols that may be activated to receive user input are visually distinct from other which one or more knowledge enhanced graphical symbols may be activated to receive user input that lack that capability.

14. A computer program product comprising:
a. a memory medium; and
b. computer instructions stored on said memory medium comprising instructions for controlling a computer to display one or more knowledge enhanced graphical symbols that contribute to the state of a first knowledge enhanced graphical symbol upon user selection of the first knowledge enhanced graphical symbol.

15. Apparatus for displaying knowledge enhanced graphical symbols, comprising:
a computing element; and
a display mechanism linked to the computing element for displaying one or more knowledge enhanced graphical symbols that contribute to the state of a first knowledge enhanced graphical symbol upon activation of the first knowledge enhanced graphical symbols.
